(19) United States
(12) Patent Application Publication
(10) Pub. No.: US 2005/0174242 A1
(43) Pub. Date: Aug. 11, 2005

(54) Monitoring method and system

(75) Inventor: Philip E. Cohen, Toronto (CA)

Correspondence Address: BERESKIN AND PARR, 40 KING STREET WEST, BOX 401, TORONTO, ON, M5H 3Y2, CA

(73) Assignee: Mobile Reach Media Inc.

(21) Appl. No.: 11/045,335

(22) Filed: Jan. 31, 2005

Related U.S. Application Data
(60) Provisional application No. 60/540,346, filed on Feb. 2, 2004.

(51) Int. Cl. G08B 23/00

(52) U.S. Cl. 340/573.4; 340/539.15

(57) ABSTRACT

A method for a parent to monitor the status of a child when the child is away from home, in which a notification engine sends regular text messages to the child. If after a selected number of messages have been sent, the child has not responded to the notification engine within a selected time, then a non-response message is sent to the parent. The child can also send a trouble message to the notification engine which will then also notify the parent. The parent can access a log of responses to check the system status at any time.

### PRIOR APPLICATION

This application claims the benefit of U.S. Provisional Application Ser. No. 60/540,346, filed Feb. 2, 2004, entitled MONITORING METHOD AND SYSTEM.

### FIELD OF THE INVENTION

This invention relates to a monitoring method and system for keeping watch over persons, e.g. over children and other loved ones while they or their parents are away from home.

### BACKGROUND OF THE INVENTION

Parents frequently worry about the safety of their children while the children are away from home. A child may be simply out for part of the day or night, or may be away on vacation, or may be in the midst of travelling. Indeed, the child may be at home with a babysitter and the parent may be away from home, and even in that situation a parent will often wish to check the well-being of his/her child.

Various methods and systems have been developed in the past for performing monitoring functions. One example is shown in U.S. Pat. No. 6,593,851 issued Jul. 15, 2003 to Aimee Bornstein. However, these prior systems have all suffered from a number of disadvantages, and the applicant is not aware of any prior systems which have found widespread acceptance.

### BRIEF SUMMARY OF THE INVENTION

Accordingly, it is an object of the present invention to provide an improved method and system for monitoring loved ones when they are separated from the person who wishes to perform the monitoring. In one aspect the invention provides a method for a first person, such as a parent, to monitor the well-being of a second person, such as a child, said method comprising:
(a) activating a notification system for said notification system to periodically send notification messages to said second person;
(b) watching at said notification system for replies from said second person to said notification messages;
(c) setting a non-response condition if said second person has not replied to said notification system after receiving a selected number of notification messages from said notification system; and
(d) causing said notification system to notify said first person with a non-response message if a non-response condition has been set.

Further objects and advantages of the invention will appear from the following description, taken together with the accompanying drawings.

### BRIEF DESCRIPTION OF THE DRAWINGS

In the drawings:

FIG. 1 is a diagrammatic view showing an internet website with sign-up screens for use with the invention;

FIG. 2 shows the internet website at FIG. 1 with a home page screen;

FIG. 3 shows the internet website of FIGS. 1 and 2 connected to a notification engine;

FIG. 4 shows the notification engine of FIG. 3 connected through communication links to parent and to child contact locations; and

FIG. 5 shows the internet website of FIGS. 1 and 2 with a “carrier-only” screen.

### DETAILED DESCRIPTION OF PREFERRED EMBODIMENT

The preferred embodiment of the invention will be described with reference to a parent monitoring the well-being of a child. However, it will be appreciated that the method and system of the invention may be used with any set of persons where one or more members of the set wishes to monitor the well-being of one or more other members of the set.

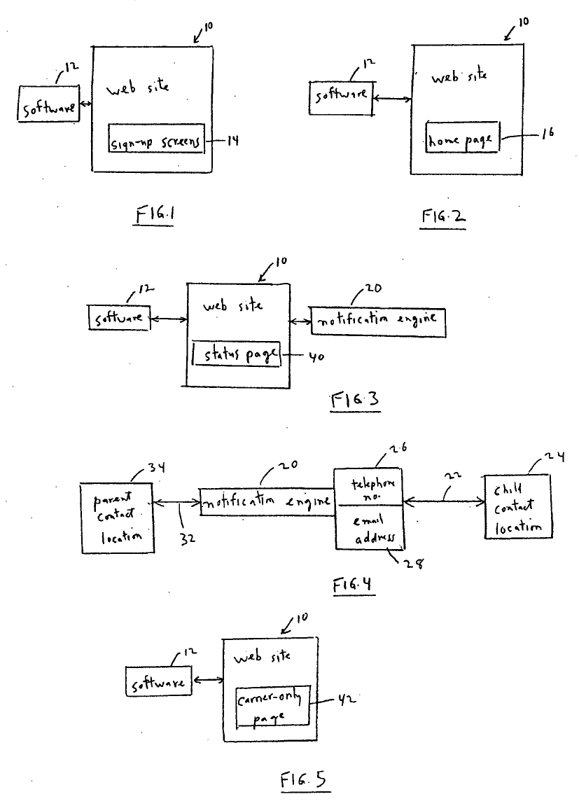

As shown in FIG. 1, a website 10 is preferably provided, the website including software 12. The software 12 provides interactive sign-up screens 14 where users of the service, e.g. parents, may sign up for the service. Typical information required for the sign-up, and to be entered on the sign-up screens 14, includes the following:
1. Parent's mobile telephone or other mobile device number (for using the notification engine to be described).
2. User name.
3. Password.
4. Email address.
5. Credit card information.
6. Billing recurrence:
   Month to month;
   Pay for the whole year.
7. Information for contacting the parent if the child does not respond. Such information can be any of:
   Email address;
   SMS (short message service number);
   WAP (wireless application protocol) contact details;
   Telephone number;
   Pager number.
8. A secondary set of non-response contact information in the event that the parents cannot be reached at the first set of contact information locations.
9. Number of children to keep track of, and their names or nick names.
10. The parent's mobile device number (if a mobile device is being used), to verify that future status requests from the parents are authentic.
11. Whether the notification engine will or will not send to the parents confirmations of each message sent to the child.

The sign-up information required for the child typically includes:
1. The mobile device number or numbers of each child (for using the notification engine).
2. The schedule of notification for each child, namely the times when the children are notified and are required to respond. The intervals between notifications can be minutes, hours, days, or in some cases even weeks.
3. The number of times a message to a child may be missed (i.e. no response made by the child) before invoking the non-response system.
4. The amount of time permitted to elapse before a second message is sent to a child, if the first message receives no response (this can typically be one minute to twenty minutes).
5. The amount of time to wait after a message has been sent to a child, and the child has not responded, before a non-response condition is set (as will be described).
6. Whether each or any child has the ability to turn the notification to him/her off and instead leave a forwarding telephone number.
7. A special code for the child to turn the notification to him/her off, e.g. “333”.
8. A special code which the child is to issue along with the “off” command if there is trouble, e.g. “313”.
9. The option to reset/change the child's on/off and trouble codes.

During the sign-up process, and if the operator of the service is a mobile telephone carrier, then to verify that the parent who is signing up is a customer of that carrier, the software 12 associated with the website 10 will send the user a text message to which the user must respond before completing the sign-up process.

The sign-up screens 14 will also normally include spaces for the parent to add information for additional children if desired, usually at an additional cost per child.

An option to add a babysitter can also be available. In that case, a parent can be away from home and can have the system send notification messages to the babysitter's device (such as a mobile phone or the parent's own landline phone). When a babysitter is to be added, the parent will set all of the same configuration options as were set for a child, but there may be some appropriate changes in view of the assumed age and responsibility of the babysitter.

Once a parent has subscribed to the system of the invention and accesses the website 10, then the software 12 will cause the website to display a home page 16 (FIG. 2) for that parent. The home page 16 will show the current status of the notification schedule for the child or other person to be monitored, and will permit the parent to change the notification schedule. An easy-to-use interface is provided to allow the parent to turn the system on and off for multiple children, so that notification messages can be sent to each child selected (but not to non-selected children), with a selected schedule of notifications for each selected child.

The following are typical options for notification schedules to a child:
1. Manually turn the system on for a specific child and then manually turn the system off for that child. (The parameters for each child which were input during the sign-up procedure will be used, unless different parameters are entered by the parent during the turn-on procedure. These parameters will include the intervals at which notification messages are sent to the child, e.g. hourly.)
2. Manually turn the system on for a specific child and have the system turn off either at a specific time, or after a preset interval.
3. Set a regular schedule for turning the system on and off at designated time periods during a week (e.g. if the child is on a regular schedule in his/her activities).

Each time the parent accesses the website 10 to turn the system on for a child, all of the current (default) parameters (e.g. non-response phone numbers, interval times, turn-off privileges, etc.) will be displayed on home page 16 (or on another appropriate page if desired).

When a parent has turned the system on for a child, this activates a notification engine 20 (FIG. 3). The notification engine 20 (which is normally embedded in the software 12) constantly monitors the website 10 information to react when a parent, or an automatic scheduler, has turned on notification.

When notification is on, the child being monitored will automatically be sent messages by the notification engine 20 over a communication link 22 (FIG. 4) to the contact location 24 for the child. The contact location 24 may be the child's mobile telephone, a landline telephone, or any other communication device. However, the notification messages are preferably text messages (so as to minimize their intrusiveness to the child), although they can alternatively be voice messages. As mentioned, the text messages can be sent using SMS or WAP (if the child has a mobile telephone).

The notification messages sent by notification engine 20 require a response from the child. The child may respond by placing a voice telephone call to the notification engine 20, or by sending it an email, or (preferably) by sending an SMS reply or other text message, such as “OK”, to the notification engine. To receive these responses, the notification engine 20 is provided with a telephone number 26 for receiving voice calls and SMS messages, and an email address 28 to receive emails. (The reply message from the child can also be a special code word or number, preferably sent by an SMS. It can alternatively be biological information, or confirmation of biological information sent by the child's telephone, e.g. a fingerprint, or confirmation of a fingerprint match, if the child's telephone has a fingerprint scanner, or an eye scan if the telephone has an eye scanner, or other biological information.)

If the child does not reply to the message from the notification engine 20, then (depending on how the parameters of the system are set) the notification engine 20 can set a non-response condition immediately, or it can send another notification to the child at a set interval (selected by the parent), e.g. one to twenty minutes after the last notification message was sent to the child. The system can be set (on the sign-up screen 14 and also on the home page 16) so that a notification which is not replied to can be sent to the child one, two or three times (but not typically more than three times) before a non-response condition is set. The time which has elapsed between when the last notification message was sent and responded to, and the time when a non-response condition is set, can be selected by the parent (as mentioned) and may vary considerably. For example, this time may vary between one minute and 24 hours (the latter time only being used under special circumstances, e.g. when the child is away camping and is out of touch for much of the 24 hour period).

While notification messages are being sent to the child, no messages are normally sent to the parent (although if the parent wishes, he/she can set the initial parameters so that confirmation of each notification message sent to a child is sent to the parent, or they may check the status of responses to date at any time). However, if a non-response condition has been set, i.e. the child has not responded after the preset number of notification messages have been sent to the child, then the notification engine 20 sends a non-response message over communication link 32 to the parent contact location 34 advising that the child has not responded. As previously described, the non-response message sent to the parent can be sent by telephone, email, SMS, WAP or via a pager. If the parent contact location is a telephone, and if the notification engine 20 detects that the telephone has answered with a voice mail message, then the non-response message can be sent to the secondary contact location provided by the parent for this purpose (e.g. another telephone).

In some cases, notification messages will not be received by the child's telephone because the batteries of the child's telephone are dead, or because the child's telephone was out of the reception area. For example, in some cases there is no mobile telephone reception in deep building basements, or in subway trains. Virtually all mobile telephone systems include signaling protocols under which the carrier's equipment is notified whether or not the mobile telephone in question has received a call. The carrier can pass this information on to the notification engine in the form of a simple signal indicating whether the child's telephone has or has not received the notification message in question.

If the notification engine 20 receives a signal that the notification message was not received by the child's telephone, then various options are available. For example, the system can continue operating as previously programmed and can continue to send notification messages to the child on the preset schedule, or alternatively the frequency with which notification messages are sent can be increased. If the child's telephone does not receive a predetermined number of notification messages, then the situation can be treated in the same way as if the messages were received but the child did not respond, i.e. a non-response condition can be set by the notification engine 20, at which time the notification engine 20 sends a non-response message to the parent contact location 34 advising that the child has not responded (and optionally advising that the reason is that the child's telephone has not received notification messages).

As shown in FIG. 3, the website 10 may include a status page 40 which shows a log of all activity within a specific date range. The status page 40 may include the following information:
1. When notification was turned on for each child, i.e. the time (and date) when the notification engine began to send notification messages to the child, and the schedule for such messages.
2. A list of each notification message sent and whether it was received by the child's telephone and whether it was replied to by the child.
3. When the last notification message was replied to.
4. Any non-response messages which have been sent to the parent.
5. When notification was turned off, and by whom (parent, child, or babysitter).

A summary of the information contained on status page 40 and described above can also be called for from the parent's mobile telephone. In addition, while normally the parameters of the notification system are set on a website, they can be set either by email from a mobile telephone with email capabilities, or by text messaging or other appropriate communication from a parent's mobile telephone.

The website 10 may include a help area with a guide to each section of the website and a printable guide to the commands used for the notification engine 20. The website 10 may also display how many months have been billed for, and an option for the parent to renew. The website 10 may handle regular billing and payments, and the payments less a fee for the administrator of the website may be remitted to the mobile device carrier.

Where the system is operated through a mobile device carrier, such as a cell phone carrier, then the carrier will normally be able to view on a “carrier-only” page 42 (FIG. 5) on the website 10 (accessed via a password), the following information for all customers:
1. Number of paying customers.
2. Number of cancelled customers.
3. Number of people who are currently subscribers to the service.

The mobile device carrier will normally also be able to view for each individual customer:
1. The customer's telephone number.
2. The customer's status on the system (active or non-active).
3. The amount billed for the current month.

The carrier can view the above information either by inputting the customer's telephone number, or by clicking a link in the aggregate data to take the carrier to an index of individual customers (displayed on the carrier-only page 42).

It is envisaged that carriers can send the verification codes of parents who are no longer using the service, so that the website operator can disable accounts on a daily basis. It is also envisaged that data will be stored on the system for (e.g.) one year, enabling parents to reactivate during that period without re-entering all of their information. A separate screen page for re-enabling disabled accounts will be provided for this purpose.

The administrator of the website will of course be able to remove users or turn off their access to the system (e.g. if they have not paid). The website administrator will also be able to obtain reports concerning the operation of the system, e.g. total users, total active users, list of users with the number of times the system has been accessed by each user, the total number of accesses per user per month or per year, and the total revenue.

As previously indicated, if the child does not reply to the message from the notification engine 20, then the notification engine 20 can react in several different ways. As mentioned, it can set a non-response condition immediately, or it can send another notification to the child at the normal interval which was previously being used, or it can send another notification to the child at a new set interval selected by the parent, e.g. one to twenty minutes after the last notification message was sent to the child.

Alternatively, if the child (more generally referred to as the target) does not reply to the message from the notification engine 20, then the software in the notification engine 20 can cause the notification engine 20 automatically to begin sending notification messages to the target at an increased frequency, without intervention by anyone. The increased frequency can be as desired. For example, if notification messages were being sent at one hour intervals, the increased frequency can be once every fifteen minutes, but after (for example) two such new messages are missed, then the frequency can be increased to (for example) once every two minutes.

The software 12 may allow the monitoring party (e.g. the parent) to determine such variables as the number of notification messages missed by the target before the increased frequency of notification message transmissions is triggered, the intervals at which the notification messages are sent when the increased frequency rate is triggered, and any non-linear acceleration in the rate of increase in the frequency of sending notification messages. Alternatively, the software 12 can have its own pre-set defaults for these variables, e.g. after one missed notification message is sent, then the system can automatically begin sending notification messages to the target at a rate of one message every two minutes.

The system can maintain a database of the history for each target for a minimum period of 24 hours following the day of activity. The history may include target information (name, phone number, notification message request) sent from the system (including times), whether or not the messages were received by the target's phone, responses sent from the target (including times), number of missed responses, who was notified of missed responses, and whether an acknowledgement was received from the monitor that they were notified.

It will be appreciated that any wireless messaging protocol can be used in the system as described.

While a preferred embodiment of the invention has been described, it will be realized that various changes can be made within the scope of the invention, and all such changes are intended to be included within the invention.

1. A method for a first person, such as a parent, to monitor the well-being of a second person, such as a child, said method comprising:
(a) activating a notification system for said notification system to periodically send notification messages to said second person;
(b) watching at said notification system for replies from said second person to said notification messages;
(c) setting a non-response condition if said second person has not replied to said notification system after receiving a selected number of notification messages from said notification system; and
(d) causing said notification system to notify said first person with a non-response message if a non-response condition has been set.

2. A method according to claim 1 wherein said notification message is a text message, thus to minimize the intrusiveness of said notification messages to said second person.

3. A method according to claim 2 wherein said selected number is one, two or three.

4. A method according to claim 3 wherein said non-response condition is set only after a selected period of time has elapsed from the last notification message to said second person.

5. A method according to claim 4 wherein said selected time is between one minute and twenty-four hours.

6. A method according to claim 2 wherein said text message uses SMS or WAP on a mobile device.

7. A method according to claim 1 wherein said second person may send a trouble message to said notification system, and when said notification system receives said trouble message, it sends a trouble message to said first person to advise of said trouble message.

8. A method according to claim 7 wherein said notification system, upon sending a trouble message to said first person, also sends a message to said second person confirming that a trouble message was sent to said first person.

9. A method according to claim 7 wherein said non-response and trouble messages may be sent by telephone, mobile telephone, SMS service or pager.

10. A method according to claim 1 wherein said non-response message is sent to a telephone, and if said telephone answers with a voice mail message, then said non-response message is sent to another telephone.

11. A method according to claim 1 and including providing, upon request by said first person, a log of notification messages, responses and non-responses.

12. A method according to claim 1 wherein said notification messages are sent to said second person at predetermined intervals, and if said second person does not reply to said notification system after receiving a selected number of notification messages, then said notification messages are sent to said second person at intervals shorter than said predetermined intervals.

13. A method according to claim 1 wherein said notification messages are sent to a mobile telephone of said second person, said method including the step of determining whether said notification messages were received by said mobile telephone, and if one or more said notification messages were not received by said mobile telephone, then changing the criteria for setting said non-response condition.

14. A method according to claim 1 and including setting parameters of said notification system on an internet website.

15. A method according to claim 1 and including setting parameters of said notification system by contacting it via a mobile telephone.
